(19) United States
(12) Patent Application Publication
(10) Pub. No.: US 2024/0193548 A1
(43) Pub. Date: Jun. 13, 2024

(54) REMITTANCE MAIL TRANSMISSION METHOD AND REMITTANCE MAIL SYSTEM

(71) Applicant: Shanghai Finmail Network Technology Co., Ltd., Shanghai (CN)

(72) Inventor: Haimin ZHANG, Shanghai (CN)

(73) Assignee: Shanghai Finmail Network Technology Co., Ltd., Shanghai (CN)

(21) Appl. No.: 18/534,717

(22) Filed: Dec. 11, 2023

(30) Foreign Application Priority Data
Dec. 13, 2022 (CN) 202211594060.1
Jan. 9, 2023 (CN) 202310024327.1

(51) Int. Cl. G06Q 10/107; G06Q 20/04; G06Q 20/40

(52) U.S. Cl. CPC G06Q 10/107; G06Q 20/047; G06Q 20/407

(57) ABSTRACT

The present invention discloses a remittance mail transmission method. Whether a received e-mail is a remittance mail is determined; in response to the received e-mail being the remittance mail, a recipient communicates with a sender to determine whether an item to be remitted is an internal remittance; in response to the item being the internal remittance, this item may be remitted directly; in response to the item not being the internal remittance, this item is placed in a waiting queue; such items may then be remitted in batches, and the item that has not been remitted successfully may continue to be placed in the waiting queue; and the items for which remittances are delayed are remitted after being merged. The present invention further discloses a remittance mail system, including a fund management server, a database server, an e-mail client, a remittance mail management server and an e-mail management server.

### REFERENCE TO RELATED APPLICATIONS

The present application claims the priorities of Chinese patent applications No. 202211594060.1, filed on Dec. 13, 2022, and Chinese patent applications No. 202310024327.1, filed on Jan. 9, 2023, the entire discloses of which applications are incorporated herein by reference.

### TECHNICAL FIELD

The present invention relates to the technical field of e-mails, in particular to a remittance mail transmission method and a remittance mail system.

### BACKGROUND ART

Digital currency/cryptocurrency refers to value, value symbols or tokens which do not rely on a third party for transmission. It is usually based on a public chain, consortium chain or block chain and adopts a consensus algorithm, and is thus hereinafter referred to as “digital currency”. Its scope also includes tokens that rely on similar network circulation, such as USDT stable coins and digital currencies using a UTXO model.

Electronic currency refers to an electronic traditional/fiat currency or tokens and related payment services. The electronic currency is a value or value symbol that relies on a third party for transmission, including a traditional/fiat currency or tokens and related payment services, such as PayPal and Alipay, and their virtualized electronic currencies.

DNS Server: Domain Name System.

Regular mail: ordinary e-mail.

Remittance mail: an e-mail whose content has a remittance identifier, such as “Pay-To” (i.e., “Pay To”).

The invention having an application number of 201910092306.7 is entitled “CURRENCY-PROTOCOL CONVERGED E-MAIL SYSTEM, AND E-MAIL SENDING AND RECEIVING METHODS THEREFOR”. The invention having an application number of 201910217445.8 is entitled “VALUE TRANSFER SYSTEM BASED ON THE DOMAN NAME SYSTEM (DNS), METHOD THEREOF AND DNS SERVER”. The invention having an application number of 202010595116.X is entitled “EMAIL-BASED VALUE TRANSFER METHOD AND VALUE TRANSFER CLUSTER SYSTEM”. The above technical solutions show that the prior art can basically achieve the combination of e-mail and value transmission, e.g., can achieve value transmission of an e-mail interaction server with a function of querying a payee address, and value transmission based on the SMTP protocol to query the payee address. However, the prior art for a remittance mail nowadays has the technical defects such as limited use scenarios and difficulty in realizing batch remittances during value transmission, making the remittance mail system inefficient and unreliable. There are also obvious deficiencies in the performance and cost of use of the entire system.

### SUMMARY OF THE INVENTION

The technical problem to be solved by the present invention is to provide a remittance mail transmission method and a remittance mail system, so as to overcome the defects in usage performances and usage cost of the remittance mail in the prior art.

In order to solve the above technical problem, the technical solution of the present invention is as follows.

A remittance mail transmission method includes the following steps:
S1, preparing, by a sender or remitter, an item to be remitted;
S2, sending, by the sender, a remittance mail to one or more recipients;
S3, determining, by the recipient, whether the received e-mail is a remittance mail based on an actual e-mail delivery address, remittance fields etc., ending the method in response to the received e-mail not being the remittance mail, and proceeding to the next step in response to the received e-mail being the remittance mail;
S4, connecting the recipient to the sender according to relevant information to make the recipient communicate with the sender, determining whether the item to be remitted is an internal remittance, proceeding to S5 in response to the item being the internal remittance, or proceeding to S6 in response to the item not being the internal remittance;
S5, performing remittance directly by the sender and the recipient by a method of updating a database;
S6, placing, by the sender, the item to be remitted into a waiting queue;
S7, checking, by the sender, whether there is a delayed remittance in the waiting queue, proceeding to S8 in response to no delayed remittance in the waiting queue, and proceeding to S9 in the presence of the delayed remittance in the waiting queue;
S8, returning to S7 after a delay time; and
S9, performing remittance in batches by the sender, informing the recipient or a payee of information indicating that the items have been successfully remitted, placing the items that have not been remitted successfully back to the queue in response to no successful remittance of the items, waiting for the next batch of remittances, and then returning to S8.

Preferably, S2 includes the following step: expanding corresponding remittance fields of the remittance mail in response to the same remittance mail containing a plurality of recipients.

Preferably, S2 includes the following step: adding a current delivery address to an e-mail header by a method including Sieve Scripts.

Preferably, S3 includes the following step: identifying, by the recipient, whether the received e-mail is a regular mail or a remittance mail through the actual e-mail delivery address and the remittance fields.

Preferably, the e-mail is determined as the remittance mail if the e-mail header contains the remittance fields, e.g., “Pay-To” and the actual delivery address belongs to a payee address identified by the remittance fields; and the e-mail is regarded as the regular mail or marked as the “remittance type mail” if the e-mail header contains the remittance fields and the actual delivery address does not belong to a payee address identified by the remittance fields.

Preferably, Pay-From is added to the e-mail header to provide a reliable e-mail address of the remitter and possible fund management server information.

Preferably, S5 or S9 includes the following step: identifying, by the recipient and the sender, a relevant remittance transaction through an internal transaction ID.

Preferably, S6 or S9 includes the following step: merging several remittance transactions with the same payee address and the same currency or several remittance transactions with the same currency into one transaction, and assigning the internal transaction IDs to the several transactions respectively.

Preferably, the merging of the remittance transactions with the same currency into one transaction includes: merging several remittance transactions with different payee addresses but with the same currency into one digital currency transaction, and assigning the corresponding internal transaction IDs respectively to the several remittance transactions that do not carry internal transaction IDs.

Preferably, S9 includes the following step: sending the post-merger digital currency transaction through a digital currency network, informing the payee or the recipient of the post-merger digital currency transaction through a transaction identifier, and confirming and updating receiving information by the payee or recipient, wherein the transaction identifier includes an internal transaction ID and/or an external transaction ID.

Preferably, S9 includes the following step: canceling the relevant remittance transaction and informing the recipient and/or sender when the specified remittance transaction cannot be completed within a preset period, or a request to cancel the transaction is received prior to the actual remittance.

The present invention further discloses a remittance mail system, which includes a fund management server, a database server, an e-mail client, a remittance mail management server and an e-mail management server, and is configured to implement any one of the above methods.

Compared with the prior art, the present invention has the following technical effects.

According to the present invention, whether the received e-mail is the remittance mail is determined through the remittance identifier; in response to the received e-mail being the remittance mail, the recipient or payee communicates with the sender to determine whether the item to be remitted is the internal remittance; in response to the item being the internal remittance, this item may be remitted directly by the method of updating a database; in response to the item not being the internal remittance, this item is placed in the waiting queue to delay the remittance; and after a certain delay, such items may be remitted in batches, and the items that have not been remitted successfully may continue to be placed in the waiting queue. Of course, the transaction time may also be set. If the specified remittance transaction cannot be completed within a preset period, the relevant remittance transaction is canceled and then the payee or recipient is informed. In addition, prior to the actual remittance of an item, the recipient or sender may also manually cancel a relevant remittance transaction, or the system may request to cancel the relevant remittance transaction. The present invention can support a plurality of payees based upon the confirmation of a remittance type, can greatly improve the performance and success rate of remittance, and can significantly reduce the remittance cost by means of transaction merging and other technologies. The remittance provided by the present invention may be applied to a value transmission system including an e-mail interaction server with a function of querying the payee address, and a value transmission system based on the SMTP protocol to query the payee address, and may also be used in any type of value transmission system, including deformation and extension etc., of the value transmission system according to actual value transmission. For some systems that can communicate with the recipient and sender respectively only through the e-mail interaction server, the relevant functions of the fund management server may be transferred to the e-mail interaction server. Afterwards, functions such as remittance-related inquiries or value transmission are completed through internal dispatching within the e-mail remittance system.

### BRIEF DESCRIPTION OF THE DRAWINGS

FIG. 1 is a flowchart of remittance preparation in a remittance mail transmission method according to the present invention;

FIG. 2 is a flowchart of external remittance in a remittance mail transmission method according to the present invention;

FIG. 3 is a flowchart of merging remittances in a remittance mail transmission method according to the present invention;

FIG. 4 is a flowchart of external payment receiving in a remittance mail transmission method according to the present invention;

FIG. 5 is a flowchart of merging remittances in a remittance mail transmission method according to the present invention;

FIG. 6 is an architecture diagram of a remittance mail system according to the present invention; and

FIG. 7 is another architecture diagram of a remittance mail system according to the present invention.

### DETAILED DESCRIPTION OF THE INVENTION

Specific embodiments of the present invention will be further illustrated below in conjunction with the accompanying drawings. It should be noted here that the description of these embodiments is used to help understand the present invention, but does not constitute a limitation to the present invention. Further, the technical features involved in various embodiments of the present invention described below may be combined with each other as long as they do not constitute a conflict with each other.

In the relevant embodiments of the present application, the relevant recipients/senders involved in the remittance mail transmission should include an e-mail recipient/sender, wherein the sender at least includes a remitter, and the recipient at least includes a payee. “Sender” and “remitter”, as well as “recipient” and “payee” are also understood equivalently. Those skilled in the art may make specific correspondences according to the type of the remittance mail, which is not limited in the present application.

### Embodiment 1

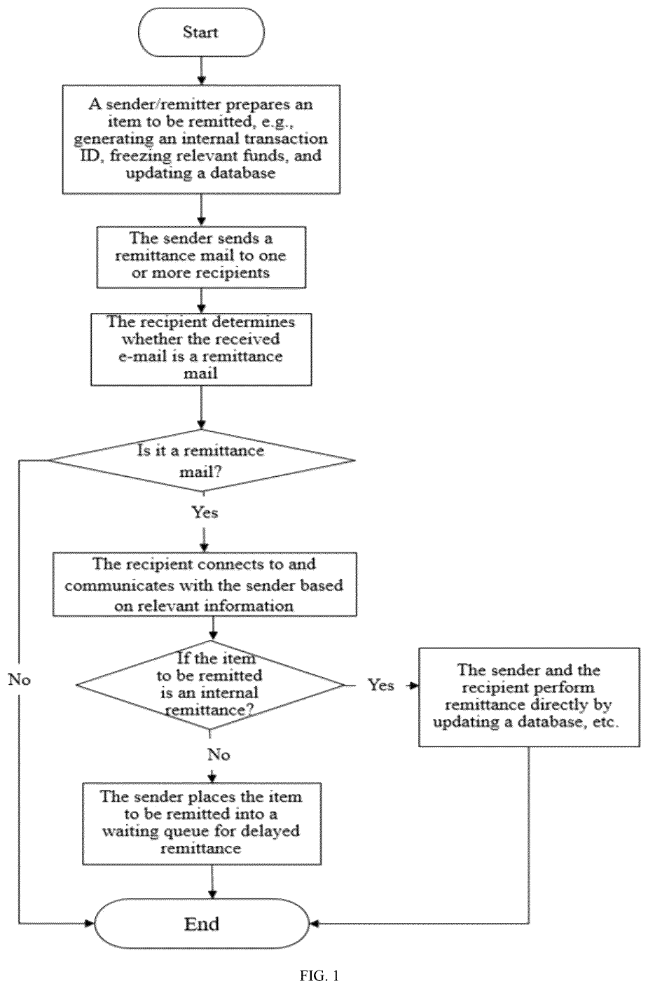

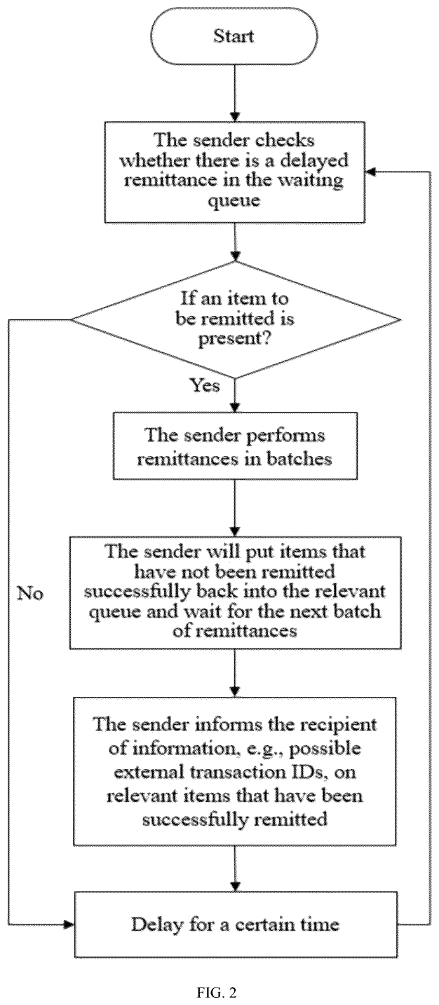

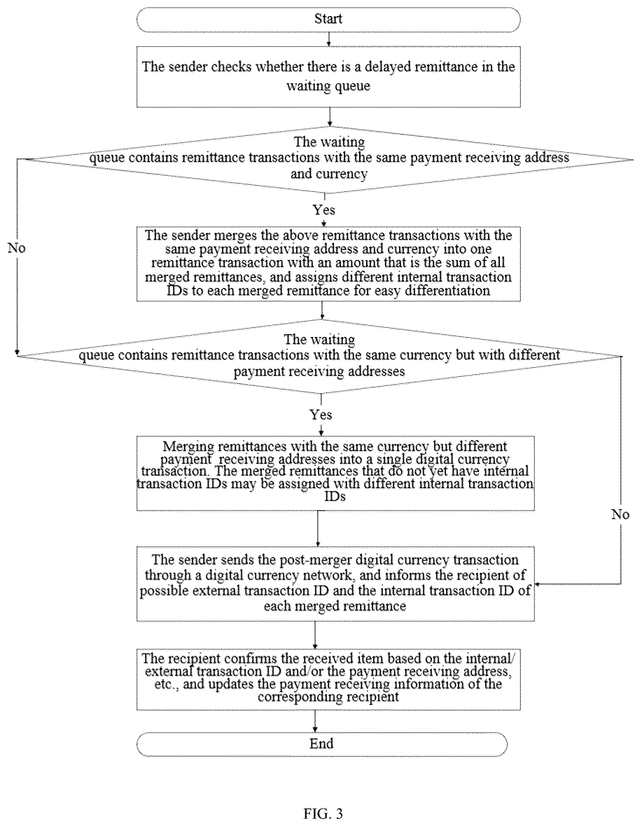

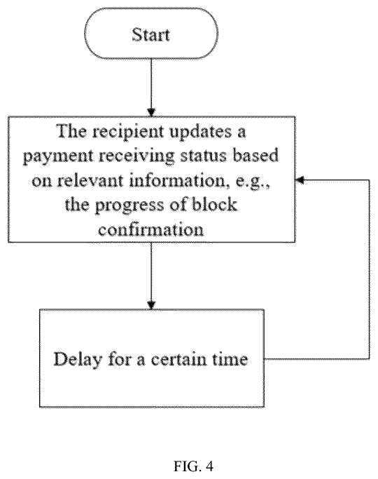

Referring to FIG. 1 to FIG. 4, a remittance mail transmission method includes the following steps.
S1: A sender or remitter prepares a remittance item.

In order to ensure the reliability, prior to sending the remittance mail, a sender fund management server only makes relevant preparations, e.g., generating an internal transaction ID, freezing related items, and updating database fields, but does not make an actual remittance.
S2: The sender sends the remittance mail to one or more recipients.

In the existing e-mail specifications, each e-mail is generally divided into an envelope portion and a content portion, while the content portion is divided into a header portion and a body portion (Chapter 2.3.1 in RFC5321, refer to https://datatracker.ietf.org/doc/html/rfc5321). During the actual transmission process, an e-mail service program performs actual reception and delivery work through sending and receiving addresses in the envelope portion, while header fields of the content portion may usually be modified arbitrarily. For example, for a To field in the header, if there is a plurality of recipients for the same e-mail, the To field will contain addresses of all recipients, instead of the currently delivered recipient address. Therefore, it is difficult to identify the e-mail address of the recipient/payee directly using To and other fields of the header portion. To obtain the current recipient address actually delivered to, the recipient address in the envelope portion may be used.

In general cases, the content portion does not contain information in the envelope portion, and the information in the envelope portion will no longer be visible after the completion of e-mail transmission. To facilitate processing, the information in the required envelope portion is added to the e-mail header in the course of receiving the e-mail. For example, the current delivery address in the envelope portion may be added to the e-mail header as follows: X-Envelope-To: abcd@domain.com.

If the recipient belongs to a To or CC address, the current delivery address is generally contained in the To field of the envelope, a possible corresponding X-Envelope-To field of the header and a possible To/Cc field of the header at the same time. If the recipient belongs to a Bcc address, the current delivery address is generally contained only in the To field of the envelope and the possible corresponding X-Envelope-To field of the header. In either case, the current delivery address can be found in both the To field of the envelope and the possible corresponding X-Envelope-To field of the header.

The current delivery address may be added to the e-mail header through e-mail scripts such as Sieve, for example an addheader statement n Sieve (RFC5293, refer to https://datatracker.ietf.org/doc/html/rfc5293). Sieve is a standard e-mail processing script and has a specification RFC5228 that is formulated by standardization organizations such as IETF, referring to https://datatracker.ietf.org/doc/html/rfc5228. Generally, the Sieve script may be called through Dovecot, etc., and cooperate with e-mail transfer programs such as Postfix to complete e-mail processing.

Corresponding remittance fields in the remittance mail may be expanded in response to the same remittance mail containing a plurality of payees or recipients. For example, if the same remittance mail needs to be sent to the following pavees at the same time:

| Payee | Amount | | Transaction ID |
|---|---|---|---|
| abcd@domain1.com | 1 | BTC | Txid1 |
| efgh@domain2.com | 10 | USDT | Txid2 |

Then, relevant information may be added to the Pay-To field, for example:
Pay-To: abcd@domain1.com; amount: 1 BTC;
txid: Txid1
efgh@domain2.com; amount: 10 USDT;
txid: Txid2

The recipient identifies the corresponding fields and processes them.

According to RFC5322, there is no length limit for an individual header field, but each line cannot exceed 998 characters, and each line is recommended to be no more than 78 characters. Therefore, the length may be adjusted as appropriate. For example, if the transaction ID is relatively long, it may be placed on a separate line. In order to ensure the uniqueness and reliability of the transaction ID, whether it is an internal remittance or an external remittance, an internal transaction ID may be used as a transaction ID to identify a relevant remittance transaction. If the actual remittance time is later than an e-mail sending time due to delays or other reasons, for the external remittance, a method of adding an external transaction ID may be used for communications between recipient (payee) and sender related servers. The external transaction ID is usually a transaction ID generated by a digital currency network or third-party digital/electronic currency service.
S3: The recipient determines whether the received e-mail is a remittance mail, ends the method in response to the received e-mail not being the remittance mail, and proceeds to the next step in response to the received e-mail being the remittance mail.

The e-mail recipient may identify whether the received e-mail is a regular mail or a remittance mail through an actual e-mail delivery address and the remittance fields. The received e-mail may be regarded as the regular mail if the header does not contain a remittance field, such as Pay-To. If the header contains the remittance field, but the actual delivery address does not belong to a payee address in the remittance field or other related fields, the received e-mail is generally regarded as the regular mail, but certain processing may be made, e.g., marking the e-mail as a “remittance type mail”; and if the actual delivery address belongs to a payee address in the remittance field and other related fields, the received e-mail is regarded as the remittance mail. The actual e-mail delivery address may be obtained through the above-mentioned method of “obtaining a real e-mail address of the recipient/payee”.

In addition to the Pay-To field, other fields or information may also be added to confirm and supplement relevant information, e.g., adding Pay-From to provide a reliable remitter e-mail address and possible fund management server information.

To ensure that the payee can receive the e-mail information, the e-mail addresses of all payees should usually be included in unambiguous recipient e-mail addresses, such as To and/or Cc.

In some cases, the recipient e-mail address may also be included in Bcc, but these cases should generally be avoided to reduce financial and legal disputes arising from anonymity. The remittance mail server and possible clients may make the check via conditional judgment.
S4: The recipient is connected to the sender according to relevant information and communicates with the sender, determines whether the item to be remitted is an internal remittance, proceeds to S5 in response to the item being the internal remittance, or proceeds to S6 in response to the item not being the internal remittance.

After the e-mail recipient successfully receives the remittance mail, a recipient fund management server communicates with the sender for actual value transmission. For this purpose, a recipient remittance mail management server may identify sender-related fund management and/or e-mail server domain name or IP through the sender address, transaction ID, etc., in the envelope and header fields of the received e-mail.
S5: This item is remitted directly between the sender and the recipient by a method of updating a database.
S6: The sender places the item to be remitted into a waiting queue.

When the sender and recipient perform the remittance directly by the method of updating the database, the internal transaction ID may be used to identify the relevant remittance transaction. In the course of processing delayed remittances in the waiting queue, several remittance transactions with the same payee address and the same currency or several remittance transactions with the same currency are merged into one transaction, and the internal transaction IDs are assigned to the several transactions respectively.

For example, for a plurality of remittance transactions with the same payee address and the same currency, the total amount may be combined into one remittance transaction, and these transactions may be distinguished by the recipients by assigning different internal transaction IDs, etc., thereby reducing additional costs required for redundant transactions and improving the efficiency and reliability.

The merging of the remittance transactions with the same currency into one transaction may include: merging several remittance transactions with different payee addresses but with the same currency into one digital currency transaction, and assigning the corresponding internal transaction IDs respectively to the several transactions that do not carry internal transaction IDs.

For example, if there are several remittance transactions with the same payee address and the same currency, after the operation of combining the total amount into one remittance transaction is completed, several remittance transactions, including the post-merger remittance transaction, with the same currency but different payee addresses, may be combined into one digital currency transaction, thereby further reducing the additional costs required for redundant transactions and improving the efficiency and reliability. A digital currency transaction may contain a plurality of remittance transactions, which will be detailed in the following specific embodiments.
S7. The sender checks whether there is a delayed remittance in the waiting queue, proceeds to S8 in response to no delayed remittance in the waiting queue, and proceeds to S9 in the presence of the delayed remittance in the waiting queue.
S8. The method returns to S7 after a delay time.
S9. The sender performs remittance in batches, informs the recipient or a payee of information indicating that the items have been successfully remitted, places the items that have not been remitted successfully back to the queue in response to no successful remittance of the items, waits for the next batch of remittances, and then returns to S8.

For merged payments, the post-merger digital currency transaction is sent through the digital currency network, the payee or the recipient is informed of the post-merger digital currency transaction through an external transaction ID corresponding to the external transaction and/or an internal transaction ID of each merged remittance, etc., and the payee or recipient confirms and updates the receiving information.

For example, the sender sends the post-merger digital currency transaction through the digital currency network, and informs the recipient of possible external transaction IDs corresponding to the external transaction and/or the internal transaction ID of each merged remittance through remittance fields in the e-mail body or the e-mail header. The recipient confirms the received item based on the internal transaction ID and/or the external transaction ID and the payee address, etc., and updates the receiving information of the corresponding recipient.

For external remittances, in some cases, the sender cannot remit items simultaneously while receiving confirmation from the recipient. For example, for digital currencies that use a UTXO model, if there are insufficient UTXOs available at the time, it is necessary to wait for the UTXOs under confirming to complete confirmation and to make them available, or use other methods to obtain available UTXOs. Therefore, this remittance may be placed in the waiting queue and then delayed. If necessary, the payee may also be informed of the relevant circumstances. For example, the remitter may obtain all delayed remittance transactions after a certain time interval and confirm whether there are conditions for remittance, e.g., having enough UTXO, etc. If the conditions are met, the corresponding remittance may be completed. If there are still remittance transactions that cannot be completed, the delay will continue until the remittance conditions are met.

In the course of processing delayed remittances in the waiting queue, the actual remittance transaction may be inconsistent with a user request after being processed internally, so the remittance transaction fee may be set by the system itself. For example, the estimated transaction fee that will enable the transaction to be confirmed within a certain amount of time is adopted.

If some remittance transactions cannot be completed within a certain period of time, for example, the remittance cannot be completed after more than 24 hours, or a request to cancel the transaction which is sent manually or by the system from the recipient/sender is received prior to the remittance, the relevant remittance transaction may be canceled and the recipient and/or sender may be informed. Therefore, the sender and recipient may communicate with each other via Web Service, Web Socket, INET, RPC, Socket, SMTP or other network or communication protocols to delete the relevant remittance transactions in the waiting queue, to update the relevant post-merger payment or digital currency transactions, and/or to update database fields, etc. The validity of the request to cancel the transaction can be guaranteed through user authentication, public/private key signature, special strings, real-time security check and/or network data validity verification, etc.

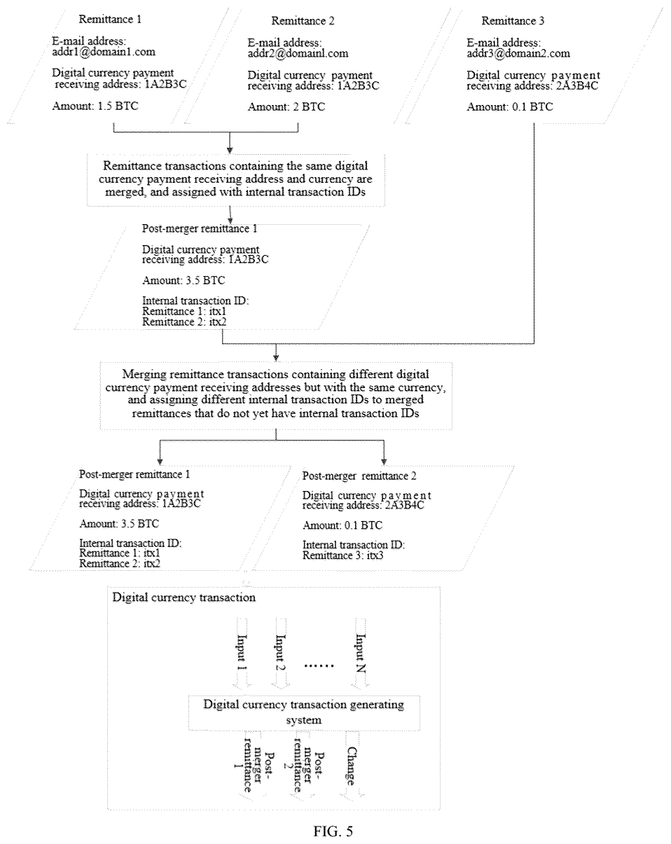

Specifically, for some digital currencies, a block usually contains several digital currency transactions, while a digital currency transaction usually contains several recipient/payer addresses and amounts (input/output), that is, a digital currency transaction may have a plurality of recipients and payers. Except for a change transaction, each payee address and amount (output) may be regarded as a remittance transaction, that is, a digital currency transaction may include a plurality of remittance transactions. Referring to FIG. 5, FIG. 5 of the present invention shows a flowchart of merging remittances in the remittance mail transmission method in junction with a specific embodiment. The following details a remittance method for merged transaction remittances for recipients with a unified payee address:

If the same remittance mail contains a plurality of payees, or a plurality of remittance mails needs to be sent in batches, the corresponding remittance transactions may be merged. For example, if the corresponding remittance fields need to be sent to the following payees at the same time:

| | Digital | | |
|---|---|---|---|
| | currency | | |
| | payment | | |
| | receiving | Transaction | |
| Remittance transaction | address | amount | |
| Remittance 1: | 1A2B3C | 1.5 | BTC |
| addr1@domain1.com | | | |
| Remittance 2: | 1A2B3C | 2 | BTC |
| addr2@domain1.com | | | |
| Remittance 3: | 2A3B4C | 0.1 | BTC |
| addr3@domain2.com | | | |

By merging remittance transactions containing the same digital currency payment receiving address and currency, and assigning internal transaction IDs, the remittances are merged for the first time to obtain a post-merger remittance 1:

| | Digital | | | Post-merger | |
|---|---|---|---|---|---|
| | currency | | | remittance 1 | |
| | payment | | | | Internal |
| | receiving | Transaction | | Merged | transaction |
| Remittance transaction | address | amount | | amount | ID |
| Remittance 1: | 1A2B3C | 1.5 | BTC | 3.5 BTC | itx1 |
| addr1@domain1.com | | | | | |
| Remittance 2: | 1A2B3C | 2 | BTC | | itx2 |
| addr2@domain1.com | | | | | |
| Remittance 3: | 2A3B4C | 0.1 | BTC | / | / |
| addr3@domain2.com | | | | | |

By merging remittance transactions containing different digital currency payment receiving addresses but with the same currency, and assigning different internal transaction IDs to the merged remittances that do not yet have internal transaction IDs, the remittances are merged for the second time to obtain a post-merger remittance 1 and a post-merger remittance 2:

| | Digital | | | Post-merger | |
|---|---|---|---|---|---|
| | currency | | | remittances 1 and 2 | |
| | payment | | | | Internal |
| | receiving | Transaction | | Merged | transaction |
| Remittance transaction | address | amount | | amount | ID |
| Remittance 1: | 1A2B3C | 1.5 | BTC | 3.5 BTC | Itx1 |
| addr1@domain1.com | | | | | |
| Remittance 2: | 1A2B3C | 2 | BTC | | itx2 |
| addr2@domain1.com | | | | | |
| Remittance 3: | 2A3B4C | 0.1 | BTC | 0.1 BTC | itx3 |
| addr3@domain2.com | | | | | |

It should be noted that the payee's domain names do not need to be in one-to-one correspondence with the digital currency payment receiving addresses. For example, for the following cases:

| | Digital | | |
|---|---|---|---|
| | currency | | |
| | payment | | |
| | receiving | Transaction | |
| Remittance transaction | address | amount | |
| Remittance 1: | 1A2B3C | 1.5 | BTC |
| addr1@domain1.com | | | |
| Remittance 2: | 1A2B3C | 2 | BTC |
| addr2@domain1.com | | | |
| Remittance 3: | 2A3B4C | 0.1 | BTC |
| addr3@domain2.com | | | |
| Remittance 4: | 2A3B4C | 0.2 | BTC |
| addr4@domain1.com | | | |

Merging results are as follows:

| | Digital | | | Post-merger | |
|---|---|---|---|---|---|
| | currency | | | remittances 1 and 2 | |
| | payment | | | | Internal |
| | receiving | Transaction | | Merged | transaction |
| Remittance transaction | address | amount | | amount | ID |
| Remittance 1: | 1A2B3C | 1.5 | BTC | 3.5 BTC | itx1 |
| addr1@domain1.com | | | | | |
| Remittance 2: | 1A2B3C | 2 | BTC | | itx2 |
| addr2@domain1.com | | | | | |
| Remittance 3: | 2A3B4C | 0.1 | BTC | 0.3 BTC | itx3 |
| addr3@domain2.com | | | | | |
| Remittance 4: | 2A3B4C | 0.2 | BTC | | itx4 |
| addr4@domain1.com | | | | | |

In this case, Remittance 1, Remittance 2 and Remittance 4 all have the same domain name domain1, but the digital currency payment receiving addresses are different, so the post-merger remittance transactions are also different. Although Remittance 3 and Remittance 4 have different domain names, they have the same digital currency payment receiving address, and thus may be merged into the same remittance transaction. In this case, the digital currency payment receiving address is not necessarily related to the domain name, but may also be related only to certain e-mail addresses, or even across domain names. That is, different e-mail addresses of the same domain name may correspond to different digital currency payment receiving addresses, while e-mail addresses of different domain names may correspond to the same Digital currency payment receiving address. By merging a plurality of digital currency transactions, the transmission efficiency can be greatly improved and the cost can be reduced.

### Embodiment 2

This embodiment provides a remittance mail system that may be an independent remittance cluster system or a cross-platform remittance mail cluster system. Those skilled in the art can obtain an independent remittance cluster system through transformation.

The remittance mail system at least includes a fund management server, a database server, an e-mail client, a remittance mail management server and an e-mail management server, and is configured to implement the remittance mail transmission method according to Embodiment 1.

The e-mail client is loaded with a remittance plug-in to provide users with an e-mail interface with a remittance identifier. The remittance identifier carries payee information, amount and currency of the fund. The currency is digital currency; and the remittance identifier is located in an e-mail header of the e-mail interface.

The remittance mail management server works together with the e-mail management server and the fund management server. After receiving an e-mail message sent by the e-mail client, the remittance mail management server determines whether the e-mail message contains the remittance identifier; the remittance mail management server schedules the e-mail management server to send the e-mail message and schedules the fund management server to perform a remittance operation according to the remittance identifier in response to the e-mail message containing the remittance identifier; and the remittance mail management server only schedules the e-mail management server to send the e-mail message in response to the e-mail message containing no remittance identifier.

The database server is configured to store fund information and possible account information of the remitter and payee. The database server interacts with the remittance mail management server and the fund management server respectively. The fund management server sends a remittance request to the database server according to scheduling instructions of the remittance mail management server. The database server updates fund information of the remitter and the payee related to this remittance according to the remittance request to realize the internal remittance.

When the fund management server receives and remits a fund through a unified interface server, an external transfer may be performed through a digital currency or digital/electronic currency network in the case of the external remittance; and the post-merger digital currency transaction is sent through the digital currency network in the case of merged payment. Through the transaction identifier including the external transaction ID corresponding to the external transaction and/or the internal transaction ID of each merged remittance, etc., the payee or recipient is informed after confirming the remittance transaction, and the receiving information is updated.

The remittance mail management server interacts with the e-mail client, the e-mail management server and the fund management server respectively to form an architecture of the e-mail remittance system. The architecture of the e-mail remittance system in this embodiment may be applied to a value transmission architecture of the e-mail interaction server having a function of querying a payee address, and a value transmission architecture based on an SMTP protocol to query the payee address and, may also be used for any applicable architecture, including deformations and extensions of an original architecture, etc., and may support communications between fund management servers through the system. For some remittance system architectures in which the recipient/sender can communicate only through the e-mail interaction server, the relevant functions of the fund management server may be transferred to the e-mail interaction server, and then complete related functions such as inquiries or remittance, etc., through internal scheduling interactions within the system.

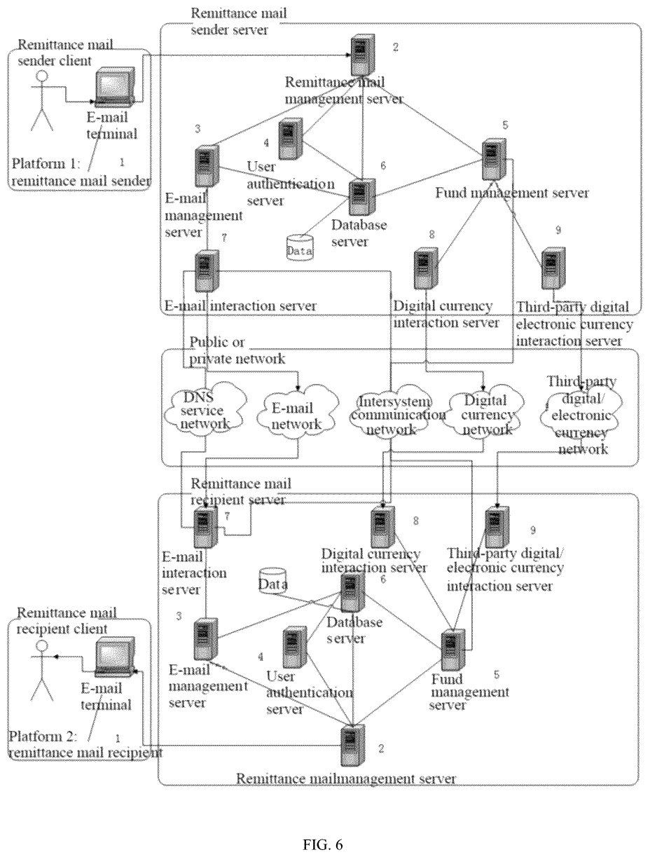

Specifically, referring to FIG. 6, the architecture of this remittance mail system includes an e-mail client 1, a remittance mail management server 2, an e-mail management server 3, a user authentication server 4, a fund management server 5, a database server 6, an e-mail interaction server 7, a digital currency interaction server 8 and a third-party digital/electronic currency interaction server 9. The fund management servers 5 are supported to be interconnected for direct communication between the systems, and the relevant functions of the fund management server 5 may also be transferred to the e-mail interaction server 7 for execution without the need of interconnection between the fund management servers 5. The e-mail interaction server 7 is provided with a fund query module. The fund query module is configured to query a payee address corresponding to a payee's e-mail address. In addition to the traditional e-mail receiving/sending functions, the e-mail interaction server 7 also carries functions similar to a unified interface interaction server for digital/electronic currency services, and performs functions such as completing relevant queries through internal scheduling interactions within the system, or implementing methods including database updates to make direct remittance and merged remittance, etc.

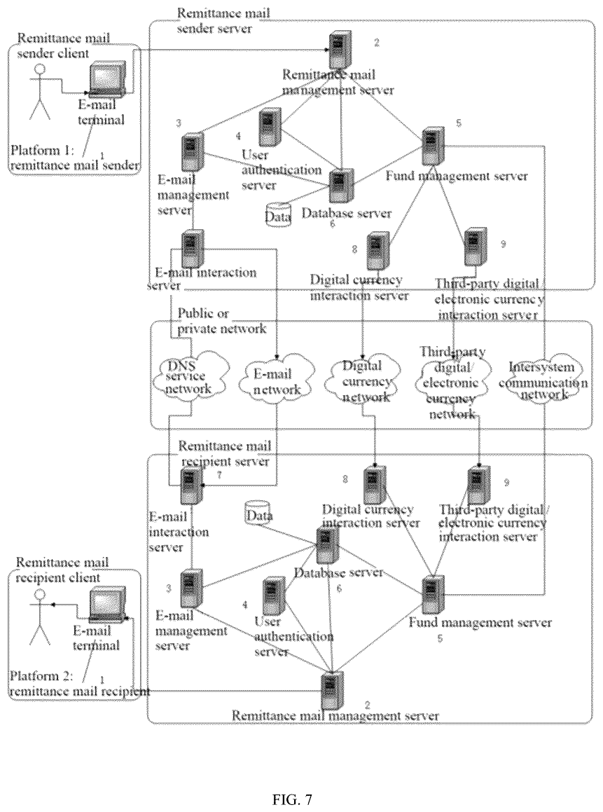

An architecture of another remittance mail system is shown in FIG. 7. The architecture of this remittance mail system is roughly the same as the cross-platform remittance mail system in FIG. 6 and supports the interconnection of the fund management servers 5 for direct communication between the systems. The relevant functions of the fund management server 5 may also be transferred to the e-mail interaction server 7 for execution without the need of interconnection between the fund management servers 5. The difference in execution is that the e-mail interaction server 7 in the remittance mail system is configured with the SMTP protocol that supports remittance instructions, which enables the e-mail interaction server 7 in the remittance mail system to query the payee address based on the configured SMTP protocol that supports remittance instructions. In addition to the traditional e-mail receiving/sending functions, the e-mail server 7 also uses extended SMTP instructions that support remittance to complete functions such as query and registration of payee addresses, and performs functions such as completing relevant queries through internal scheduling and interactions within the systems, or implementing methods including database updates to make direct remittance and merged remittance, etc.

It should be noted that in the above system architecture, the interconnection between the recipient/sender fund management servers 5 is optional. If there is no interconnection, the relevant functions will be transferred to the e-mail interaction server 7.

The embodiments of the present invention have been described in detail above with reference to the accompanying drawings, but the present invention is not limited to the described embodiments. For those skilled in the art, various changes, modifications, substitutions and modifications made to these embodiments, without departing from the principle and spirit of the present invention, still fall within the protection scope of the present invention.

1. A remittance mail transmission method, comprising the following steps:
S1, preparing, by a sender or remitter, an item to be remitted;
S2, sending, by the sender, a remittance mail to one or more recipients;
S3, determining, by the recipient, whether the received e-mail is a remittance mail, ending the method in response to the received e-mail not being the remittance mail, and proceeding to the next step in response to the received e-mail being the remittance mail;
S4, connecting the recipient to the sender according to relevant information in the remittance mail to make the recipient communicate with the sender, determining whether the item to be remitted is an internal remittance, proceeding to S5 in response to the item being the internal remittance, or proceeding to S6 in response to the item not being the internal remittance;
S5, performing remittance directly by the sender and the recipient by a method of updating a database;
S6, placing, by the sender, the item to be remitted into a waiting queue;
S7, checking, by the sender, whether there is a delayed remittance in the waiting queue, proceeding to S8 in response to no delayed remittance in the waiting queue, and proceeding to S9 in response to the presence of the delayed remittance in the waiting queue;
S8, returning to S7 after a delay time; and
S9, performing remittance in batches by the sender, informing the recipient or a payee of information indicating that the items have been successfully remitted, placing the items that have not been remitted successfully back to the queue in response to no successful remittance of the items, waiting for the next batch of remittances, and then returning to S8.

2. The remittance mail transmission method according to claim 1, wherein S2 comprises the following step: expanding corresponding remittance fields of the remittance mail in response to the same remittance mail containing a plurality of recipients.

3. The remittance mail transmission method according to claim 1, wherein S2 comprises the following step: adding a current delivery address to an e-mail header by a method including Sieve Scripts.

4. The remittance mail transmission method according to claim 3, wherein S3 comprises the following step: identifying, by the recipient, whether the received e-mail is a regular mail or a remittance mail through an actual e-mail delivery address and the remittance fields.

5. The remittance mail transmission method according to claim 4, wherein the received e-mail is determined as the remittance mail if the e-mail header contains the remittance fields and the actual delivery address belongs to a payee address identified by the remittance fields; and the received e-mail is regarded as the regular mail or marked as the “remittance type mail” if the e-mail header contains the remittance fields and the actual delivery address does not belong to the payee address identified by the remittance fields.

6. The remittance mail transmission method according to claim 5, wherein Pay-From is added to the e-mail header to provide a reliable remitter e-mail address and possible fund management server information.

7. The remittance mail transmission method according to claim 1, wherein S5 or S9 comprises the following step:
identifying, by the recipient and the sender, a relevant remittance transaction through an internal transaction ID.

8. The remittance mail transmission method according to claim 1, wherein S6 or S9 comprises the following step: merging several remittance transactions with the same payee address and the same currency, or several remittance transactions with the same currency, into one transaction, and assigning the internal transaction IDs to the several transactions respectively.

9. The remittance mail transmission method according to claim 8, wherein the merging of the remittance transactions with the same currency into one transaction comprises: merging several remittance transactions with different payee addresses but with the same currency into one digital currency transaction, and assigning the corresponding internal transaction IDs respectively to the several remittance transactions that do not carry internal transaction IDs.

10. The remittance mail transmission method according to claim 9, wherein S9 comprises the following step: sending the post-merger digital currency transaction through a digital currency network, informing the payee or the recipient of the post-merger digital currency transaction through a transaction identifier, and conforming and updating receiving information by the payee or recipient, wherein
the transaction identifier comprises an internal transaction ID and/or an external transaction ID.

11. The remittance mail transmission method according to claim 1, wherein S9 comprises the following step: canceling the relevant remittance transaction and informing the recipient and/or sender when the specified remittance transaction cannot be completed within a preset period, or a request to cancel the transaction is received prior to the actual remittance.

12. A remittance mail system, comprising a fund management server, a database server, an e-mail client, a remittance mail management server and an e-mail management server, and being configured to implement the method according to claim 1.
